(19) United States
(12) Patent Application Publication
(10) Pub. No.: US 2025/0026933 A1
(43) Pub. Date: Jan. 23, 2025

(54) A POLYSILOXANE COMPOSITION

(71) Applicant: WACKER CHEMIE AG, Munich (DE)

(72) Inventors: Junshan YIN, Shanghai (CN); Haigang KANG, Shanghai (CN)

(73) Assignee: WACKER CHEMIE AG, Munich (DE)

(21) Appl. No.: 18/714,130

(22) PCT Filed: Jan. 10, 2022
(86) PCT No.: PCT/CN2022/070982

§ 371 Date: May 29, 2024

(51) Int. Cl. C08L 83/06; C08K 3/22

(52) U.S. Cl. CPC C08L 83/06; C08K 3/22; C08K 2003/2227; C08K 2201/001; C08K 2201/003; C08L 2205/025

(57) ABSTRACT

The present invention relates to a lightweight silicone composition with high thermal conductivity. It contains vinyl silicone oil, (C-1) aluminum hydroxide with an average particle diameter greater than or equal to 0.1 μm and less than or equal to 4 μm, (C-2) aluminum hydroxide with an average particle diameter greater than or equal to +μm and less than or equal to 20 μm, (C-3) Aluminum hydroxide with an average particle diameter of 80 μm or more and 100 μm or less. The composition can be used in the technical field of thermally conductive materials.

### TECHNICAL FIELD

The present invention relates to the technical field of thermally conductive silicone compositions.

### BACKGROUND

cn104718254b Ex. 1 discloses a polyurethane system which contains a variety of heat conductive fillers (the filling rate of the heat conductive filler is 0.75). The composition contains aluminum hydroxide with average particle diameters of 125 μm, 40 μm, 2 μm and 2.7 μm, wherein the amount of aluminum hydroxide with an ultra-large particle diameter of 125 μm is about 50 wt %, and the total weight of the heat conductive filler is calculated as 100 wt %.

cn112778768a Ex. 5 discloses a silicone gel system containing heat conductive fillers, which contains a vinyl silicone oil, a hydrogen-containing silicone oil, a catalyst, an inhibitor, a coupling agent octyltrimethoxysilane and aluminum hydroxide of different particle sizes. In the composition, the dosage ratio of aluminum hydroxide with different average particle diameters is 1 μm: 10 μm: 60 μm=1.5:2.5:6.

JP5304588B2 Ex. 4 discloses a heat conductive silicone composition, which contains a vinyl silicone oil, a hydrogen-containing silicone oil, an alkoxy-modified silicone oil, and aluminum hydroxide with different particle diameters. The amount ratio of aluminum hydroxide with different particle diameters is 1 μm: 10 μm: 50 μm=2:4:4.

### SUMMARY OF INVENTION

The object of the present invention is to obtain a light-weight, low-viscosity, high-thermal-conductivity composition under high filling rate.

The present invention provides a composition, which contains:
a component (A), that is an organopolysiloxane, preferably a component (A-1) that is an organopolysiloxane having two or more alkenyl groups per molecule;
optional a component (B) that is an organohydrogenpolysiloxane having two or more hydrogen atoms directly bonded to silicon atoms and is contained in such an amount that the number of moles of hydrogen atoms directly bonded to silicon atoms in the component (B) is 0.1 to 5.0 times the number of moles of alkenyl groups derived from the component (A-1);
a component (C) that is a heat conductive filler

(C) component contains
10-25 wt % (C-1) aluminum hydroxide with an average particle diameter greater than or equal to 0.1 μm and less than or equal to 4 μm,
   for example (C-1) the average particle diameter is 0.8, 1.0, 1.2, 1.4, 1.6, 1.8, 2.0, 2.2, 2.4, 2.6, 2.8 μm, and the content is 14 wt %, 16 wt %, 18 wt %, 20 wt %, 22 wt %, 24 wt %;
18-37 wt % (C-2) aluminum hydroxide with an average particle diameter of 4 μm or more and 20 μm or less,
   for example (C-2) the average particle diameter is 6, 8, 10, 12, 14, 16, 18 μm, and the content is 20 wt %, 22 wt %, 24 wt %, 26 wt %, 28 wt %, 30 wt %, 32 wt %, 34 wt %, 36 wt %,
48-65 wt % (C-3) aluminum hydroxide with an average particle diameter greater than or equal to 80 μm and less than or equal to 100 μm,
   for example (C-3) the average particle diameter is 82, 84, 86, 88, 90, 92, 94, 96, 98 μm, and the content is 50 wt %, 52 wt %, 54 wt %, 56 wt %, 58 wt %, 60 wt %, 62 wt %, 64 wt %,
in (C-1), (C-2) and (C-3), the component (C) in the composition is calculated as 100 wt %,
optional a component (D) that is a platinum group metal-based curing catalyst having a platinum group metal element content of 0.1 to 1,000 ppm relative to the component (A-1) based on mass,
wherein the filling rate of the heat conductive filler is greater than or equal to 0.88, preferably greater than or equal to 0.89, preferably greater than or equal to 0.90.

In the present invention, the filling rate=total heat conductive filler amount/total weight of the composition. Generally, the filling rate which is greater than or equal to 0.88 is considered as the high filling rate.

The composition as described above, wherein the total amount of all aluminum hydroxide is greater than 95 wt %, preferably greater than 99 wt %, more preferably greater than 99.9 wt %, and calculated based on the total amount of heat conductive filler being 100 wt %.

The composition as described above, wherein the total amount of all aluminum hydroxide is greater than 95 wt %, preferably greater than 99 wt %, and more preferably greater than 99.9 wt %, and the total amount of fillers is calculated as 100 wt %.

The composition as described above, wherein the density of the composition is equal to or less than 2.4 g/cm³, preferably equal to or less than 2.2 g/cm³, and more preferably equal to or less than 2.1 g/cm³.

The composition as described above, wherein the thermal conductivity of the composition is greater than or equal to 3.1 W/mK, preferably greater than or equal to 3.2 W/mK, more preferably greater than or equal to 3.3 W/mK.

In the composition as described above, (C-1), (C-2) and (C-3) aluminum hydroxide is all in amorphous form.

In the composition as described above, the amount of the spherical filler is less than 10% by weight, preferably less than 1% by weight, calculated based on the weight of the composition as 100% by weight.

In the composition as described above, the amount of spherical alumina is less than 10% by weight, preferably less than 1% by weight, based on the weight of the composition as 100% by weight.

In the composition as described above, in (C-1), (C-2) and (C-3) aluminum hydroxide, the content of Al(OH)₃ is greater than or equal to 99.1%, preferably greater than or equal to 99.5%.

The composition as described above, wherein (C-1), (C-2) and (C-3) aluminum hydroxide, wherein the content of Na₂O is less than or equal to 0.1%, preferably the total content of water-soluble Na₂O and lattice state Na₂O is less than or equal to 0.1%.

The composition as described above, wherein at least one of (C-1), (C-2) and (C-3) aluminum hydroxide is surface-treated, preferably treated by component (E-1).

The composition as described above, wherein (C-1) aluminum hydroxide is surface-treated treated by component (E-1).

The composition as described above, wherein (C) component containing
10-20 wt % (C-1) Aluminum hydroxide with an average particle diameter greater than or equal to 0.5 μm and less than or equal to 3 μm,
20-35 wt % (C-2) Aluminum hydroxide with an average particle diameter greater than or equal to 7 μm and greater than or equal to 15 μm,
50-60 wt % (C-3) Aluminum hydroxide with an average particle diameter greater than or equal to 85 μm and greater than or equal to 95 μm, in (C-1), (C-2) and (C-3), the component (C) in the composition is calculated as 100% by weight.

The composition as described above, wherein the weight ratio of the surface-treated aluminum hydroxide to the un-surface-treated aluminum hydroxide is less than 0.3, preferably less than 0.2, and more preferably less than 0.15.

The composition as described above, wherein the weight ratio of (C-1)/(C-3) is between 0.2 and 0.4, preferably between 0.22 and 0.38, for example 0.25, 0.27, 0.29, 0.31, 0.33, 0.35.

The composition as described above, wherein the weight ratio of (C-2)/(C-3) is between 0.2 and 0.8, preferably between 0.25 and 0.75, for example 0.3, 0.4, 0.5, 0.6, 0.7.

The composition as described above, wherein the ratio of (C-1)/(C-2) average particle diameter is between 8-12, preferably between 9-11, more preferably between 9.5-10.5, for example 9.6, 9.8, 10.0, 10.2, 10.4.

The composition as described above, wherein the ratio of (C-1)/(C-3) average particle diameter is between 70-120, preferably between 75-100, more preferably between 80-99, for example 82, 84, 86, 88, 90, 92, 94, 96, 98.

The composition as described above, wherein the ratio of (C-2)/(C-3) average particle diameter is between 7.0-12.0, preferably between 7.5-10, more preferably between 8.0-9.9, for example 8.2, 8.4, 8.6, 8.8, 9.0, 9.2, 9.4, 9.6, 9.8.

The definition of the average particle diameter refers to the value of the cumulative average particle diameter (D50 median diameter) measured by the particle size analyzer LS 13 320 manufactured by BECKMAN COULTER on a volume basis.

(C-1) the aluminum hydroxide sample is prepared by the solution method. 0.1 g (C-1) sample is placed in 10 ml of absolute ethanol, dispersed by ultrasonic (100 w) and stirred for 2 minutes, so that the aluminum hydroxide is fully dispersed. Take out 2-3 drops of sample solution and put them into the sample cell of the particle size analyzer.

(C-2) and (C-3) aluminum hydroxide samples (or other heat conductive fillers with an average particle diameter greater than or equal to 7 μm) are prepared by the dry powder method, and an appropriate amount of the sample dried at room temperature is placed into the loading cylinder of the particle size analyzer. Insert the loading cylinder into the detection slot of the device.

In the present invention, the particle size distribution of (C-1), (C-2) and (C-3) aluminum hydroxide is unimodal, or their particle sizes meet unimodal or almost unimodal particle size distributions.

The almost unimodal particle size distributions in the present invention means that in the volume integral map of the measurement sample, there might be two or more peaks, but the volume integral area of the main peak accounts for more than 80% of the entire volume integral area, preferably more than 85%, more preferably more than 90%, more preferably more than 95%.

Spherical fillers, whose outer contour is generally spherical, are filler materials which are obtained from the amorphous fillers treated by chemical and/or physical (including heat treatment) processes.

Spherical alumina is a product obtained after heat treatment of amorphous alumina, and the outer contour is generally spherical.

Preferably, the thermal conductive silicone composition further comprises a component (E) in an amount of 1 to 100 parts by mass, preferably 1 to 50 parts by mass, relative to 100 parts by mass of the component (A), wherein the component (E) is any one or more selected from (E-1):
(E-1) an alkoxysilane compound shown by the following formula (1); and

R¹ₐR²_{b}Si(OR³)_{4-a-b} (1)

wherein each R¹ independently represents an alkyl group having 1 to 24 carbon atoms, preferably 6 to 24 carbon atoms, more preferably 12 to 18 carbon atoms, each R² independently represents an unsubstituted or substituted hydrocarbon group having 1 to 10 carbon atoms, preferably methyl, ethyl, each R³ independently represents an alkyl group having 1 to 6 carbon atoms, preferably methyl, ethyl, a represents an integer of 1 to 3, and b represents an integer of 0 to 2, provided that a+b is an integer of 1 to 3.

In the present invention, the weight ratio of (C) component to (E-1) component is between 100-800, preferably between 200-500, and more preferably between 200-400.

Additionally, the thermal conductive silicone composition preferably has an absolute viscosity at 25° C. of 250 000 mPa's or less, preferably 200 000 mPa's or less, more preferably 170 000 mPa's or less.

Such a thermal conductive silicone composition is excellent in moldability.

In addition, the present invention provides a thermal conductive silicone cured product comprising a cured product of the thermal conductive silicone composition.

Such a thermal conductive silicone cured product is excellent in both thermal conduction and light-weight characteristic.

As described above, according to the inventive thermal conductive silicone composition, a silicone composition containing specific organopolysiloxane, hydrogenpolysiloxane, and heat conductive filler is elaborately adjusted and formulated, so that the base material is filled with the heat conductive filler at high density. This makes it possible to provide a thermal conductive silicone composition which results in a thermal conductive silicone cured product having high thermal conduction and light weight: a heat conductivity of 3.1 W/m·K or more and a density of 2.4 g/cm³ or less. Such a thermal conductive silicone cured product is useful, particularly for cooling electronic parts through thermal conduction, as a heat conducting material interposed at an interface between a thermal surface of a heat-generating electronic part and a heat dissipating member such as a heat sink or a circuit substrate.

As noted above, there have been demands for the developments of a thermal conductive silicone cured product (thermal conductive resin molded product) having high thermal conduction and light weight, and a thermal conductive silicone composition for forming the cured product.

The present inventors have earnestly studied to achieve the above object and consequently found that a thermal conductive silicone cured product having high thermal conduction and light weight, such as a heat conductivity of 3.1 W/m·K or more and a density of 2.4 g/cm³ or less, can be obtained by elaborately adjusting and formulating a silicone composition containing specific organopolysiloxane, hydrogenpolysiloxane, and heat conductive filler to fill the base material with the heat conductive filler at high density. This finding has led to the completion of the present invention.

Specifically, the present invention is a thermal conductive silicone composition comprising:

### Component (A): Organopolysiloxane, Preferably Component (A-1): Alkenyl Group-Containing Organopolysiloxane

The component (A) is an organopolysiloxane. The component (A) serves as a main component of the inventive composition. In general, the main chain portion is normally composed of repeated basic diorganosiloxane units, but this molecular structure may partially contain a branched structure, or may be a cyclic structure. Nevertheless, the main chain is preferably linear diorganopolysiloxane from the viewpoint of physical properties of the cured product, such as mechanical strength.

The component (A-1) is an alkenyl group-containing organopolysiloxane in which the number of silicon atom-bonded alkenyl groups is at least two per molecule. The component (A-1) serves as a main component of the inventive composition. In general, the main chain portion is normally composed of repeated basic diorganosiloxane units, but this molecular structure may partially contain a branched structure, or may be a cyclic structure. Nevertheless, the main chain is preferably linear diorganopolysiloxane from the viewpoint of physical properties of the cured product, such as mechanical strength.

Functional groups bonded to a silicon atom include an unsubstituted or substituted monovalent hydrocarbon group. Examples thereof include alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups, such as a cyclopentyl group, a cyclohexyl group, and a cycloheptyl group; aryl groups, such as a phenyl group, a tolyl group, a xylyl group, a naphthyl group, and a biphenylyl group; aralkyl groups, such as a benzyl group, a phenylethyl group, a phenylpropyl group, and a methylbenzyl group; and groups obtained from these groups by substituting a part or all of hydrogen atoms bonded to a carbon atom(s) therein with a cyano group, a halogen atom, such as fluorine, chlorine, and bromine, or the like. Examples of such substituted groups include a chloromethyl group, a 2-bromoethyl group, a 3-chloropropyl group, a 3,3,3-trifluoropropyl group, a chlorophenyl group, a fluorophenyl group, a cyanoethyl group, a 3,3,4,4,5,5,6,6,6-nonafluorohexyl group, etc. Typical examples of the functional group include ones having 1 to 10 carbon atoms, and particularly typical examples thereof include ones having 1 to 6 carbon atoms. Preferable examples of the functional group include unsubstituted or substituted alkyl groups having 1 to 3 carbon atoms, such as a methyl group, an ethyl group, a propyl group, a chloromethyl group, a bromoethyl group, a 3,3,3-trifluoropropyl group, and a cyanoethyl group; and unsubstituted or substituted phenyl groups, such as a phenyl group, a chlorophenyl group, and a fluorophenyl group. Additionally, all the functional groups bonded to a silicon atom do not have to be the same.

Furthermore, the alkenyl group normally has about 2 to 8 carbon atoms. Examples thereof include a vinyl group, an allyl group, a propenyl group, an isopropenyl group, a butenyl group, a hexenyl group, a cyclohexenyl group, etc. Among these, lower alkenyl groups, such as a vinyl group and an allyl group, are preferable and a vinyl group is particularly preferable. Note that the number of the alkenyl groups has to be two or more per molecule, and the alkenyl groups are each preferably bonded to only a silicon atom at a terminal of the molecular chain to make the resulting cured product have favorable flexibility.

The component (A) organopolysiloxane has a viscosity at 25° C. in a range of preferably 10 to 100,000 mPa·s, particularly preferably 50 to 50,000 mPa·s, more preferably 50 to 20,000 mPa·s, more preferably 50 to 2,000 mPa·s. The component (A) an organopolysiloxane is preferably a polydimethylsiloxane.

The component (A-1): Alkenyl Group-Containing Organopolysiloxane has a viscosity at 25° C. in a range of preferably 10 to 100,000 mPa·s, particularly preferably 50 to 10,000 mPa·s, more preferably 50 to 1,000 mPa·s, more preferably 50 to 200 mPa·s. When the viscosity is 10 mPa·s or more, the resulting composition has favorable storage stability. Meanwhile, when the viscosity is 100,000 mPa·s or less, the resulting composition has favorable extensibility. The component (A-1) alkenyl group-Containing Organopolysiloxane is perferably a vinyl-terminated polydimethyl-siloxane.

One kind of the organopolysiloxane of the component (A) may be used alone, or two or more kinds thereof having different viscosity or the like may be used in combination.

One kind of the alkenyl group-containing organopolysiloxane of the component (A-1) may be used alone, or two or more kinds thereof having different viscosity or the like may be used in combination.

### Optional Component (B): Organohydrogenpolysiloxane

The component (B) is an organohydrogenpolysiloxane which has at least two, preferably 2 to 100, hydrogen atoms directly bonded to silicon atoms (Si—H groups) per molecule. This component works as a crosslinking agent of the component (A-1). Specifically, a Si—H group in the component (B) is added to an alkenyl group in the component (A-1) by a hydrosilylation reaction that is promoted by a platinum group metal-based curing catalyst as the component (D) to be described later, thereby forming a three-dimensional network structure having a crosslinked structure. Note that if the number of Si—H groups per molecule in the component (B) is less than 2, no curing occurs.

The organohydrogenpolysiloxane to be used can be shown by the following average structural formula (4), but is not limited thereto.

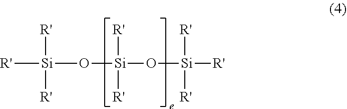

In the formula, each R′ independently represents a hydrogen atom or an unsubstituted or substituted monovalent hydrocarbon group containing no aliphatic unsaturated bond, and at least two R's are hydrogen atoms; e represents an integer of 1 or more.

Examples of the unsubstituted or substituted monovalent hydrocarbon group containing no aliphatic unsaturated bond as R′ other than hydrogen in the formula (4) include alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups, such as a cyclopentyl group, a cyclohexyl group, and a cycloheptyl group; aryl groups, such as a phenyl group, a tolyl group, a xylyl group, a naphthyl group, and a biphenylyl group; aralkyl groups, such as a benzyl group, a phenylethyl group, a phenylpropyl group, and a methylbenzyl group; and groups obtained from these groups by substituting a part or all of hydrogen atoms bonded to a carbon atom(s) therein with a cyano group, a halogen atom, such as fluorine, chlorine, and bromine, or the like. Examples of such substituted groups include a chloromethyl group, a 2-bromoethyl group, a 3-chloropropyl group, a 3,3,3-trifluoropropyl group, a chlorophenyl group, a fluorophenyl group, a cyanoethyl group, a 3,3,4,4,5,5,6,6,6-nonafluorohexyl group, etc. Typical examples of the monovalent hydrocarbon group include ones having 1 to 10 carbon atoms, and particularly typical examples thereof include ones having 1 to 6 carbon atoms. Preferable examples of the monovalent hydrocarbon group include unsubstituted or substituted alkyl groups having 1 to 3 carbon atoms, such as a methyl group, an ethyl group, a propyl group, a chloromethyl group, a bromoethyl group, a 3,3,3-trifluoropropyl group, and a cyanoethyl group; and unsubstituted or substituted phenyl groups, such as a phenyl group, a chlorophenyl group, and a fluorophenyl group. Additionally, all R's do not have to be the same.

The amount of the component (B) added is such that, relative to 1 mole of alkenyl groups derived from the component (A-1), the amount of Si—H groups derived from the component (B) is 0.1 to 5.0 moles (i.e., the number of moles of the hydrogen atoms directly bonded to silicon atoms is 0.1 to 5.0 times the number of moles of the alkenyl groups derived from the component (A-1)), preferably 0.3 to 2.0 moles, further preferably 0.5 to 1.0 moles. If the amount of the Si—H groups derived from the component (B) is less than 0.1 moles relative to 1 mole of the alkenyl groups derived from the component (A-1), no curing occurs, or the strength of the cured product is so insufficient that the molded product cannot keep the shape and cannot be handled in some cases. Meanwhile, if the amount exceeds 5.0 moles, the cured product may become inflexible and brittle.

One kind of the organopolysiloxane of the component (B) may be used alone, or two or more kinds thereof having different viscosity or the like may be used in combination.

The composition as described above, wherein component (B) could contains (B-1) and (B-2).

Component (B-1) the organic hydrogen-containing polysiloxane is an organic hydrogen-containing polysiloxane having at least 3, preferably 3-100 hydrogen atoms (Si—H groups) directly bonded to silicon atoms in one molecule, wherein the hydrogen content is between 0.5-4 mmol/g, preferably between 0.8-3 mmol/g, more preferably between 1.1-2.7 mmol/g, and more preferably between 1.5-2.3 mmol/g.

Component (B-2) the organic hydrogen-containing polysiloxane of component is an organic hydrogen-containing polysiloxane having 2 hydrogen atoms (Si—H groups) directly bonded to silicon atoms in one molecule, wherein hydrogen content is between 0.01-1.5 mmol/g, preferably between 0.1-1.2 mmol/g, more preferably between 0.3-1.0 mmol/g, more preferably between 0.4-0.8 mmol/g.

The composition as described above, wherein component (B) contains (B-1) and (B-2), and the amount of component (B-1) is between 0.5-3 wt %, preferably 1.5-2.5 wt %, based on the component (A-1) calculated as 100 wt %.

The composition as described above, wherein component (B) contains (B-1) and (B-2), and the amount of component (B-2) is between 10-50 wt %, preferably between 20-40 wt %, based on the component (A-1) calculated as 100 wt %.

### Component (C): Heat Conductive Filler

Aluminum hydroxide is inexpensive and has a density of 2.42 g/cm³, which is quite lower than that of alumina. Moreover, aluminum hydroxide suppresses precipitation of the heat conductive filler in the silicone composition, and also contributes to the weight reduction of devices.

Further, aluminum hydroxide has a Mohs hardness of 3 and is very soft in comparison with alumina. Abrasion of a reaction furnace and stirring blade is suppressed, and aluminum hydroxide is useful as a heat conductive filler having flame-retarding effect and insulating effect. However, aluminum hydroxide has a lower heat conductivity than alumina. Hence, when aluminum hydroxide is used to increase the heat conductivity of a silicone thermal conductive composition and a cured product thereof, filling with the aluminum hydroxide at high density is required. Nonetheless, such high-density filling is very difficult. For this reason, it has been presumably difficult to produce a thermal conductive silicone cured product having a heat conductivity of 3.1 W/m·K or more in which aluminum hydroxide accounts for 0.9 or more of the total parts by mass of heat conductive fillers. The present invention overcomes this problem of conventional techniques by elaborately adjusting and formulating a silicone composition containing specific organopolysiloxane, hydrogen-polysiloxane, and heat conductive filler to fill the base material with the heat conductive filler at high density. The present invention provides a thermal conductive silicone composition which results in a thermal conductive silicone cured product having high thermal conduction and light weight.

Preferably, the component (C) contains:
10-25 wt % (C-1) aluminum hydroxide having an average particle diameter of 0.1 μm or more and less than 4 μm, for example, the average particle diameter is 0.8, 1.0, 1.2, 1.4, 1.6, 1.8, 2.0, 2.2, 2.4, 2.6, 2.8 μm,
18-37 wt % (C-2) aluminum hydroxide having an average particle diameter of 4 μm or more and 20 μm or less, for example, the average particle diameter is 6, 8, 10, 12, 14, 16, 18 μm, and
48-65 wt % (C-3) aluminum hydroxide having an average particle diameter of 80 μm or more and 100 μm or less, for example, the average particle diameter is 82, 84, 86, 88, 90, 92, 94, 96, 98 μm,
the amount of (C-1), (C-2) and (C-3) mentioned above is calculated based on 100% by weight of component (C) in the composition.

In this manner, particles including aluminum hydroxide with different particle sizes as main components are elaborately combined. Specifically, the components (C-1) small-diameter particles, (C-2) medium-diameter particles and (C-3) larger-diameter particles are combined at a carefully examined blend ratio. This enables the high-density filling in the base material in such a manner that the small-medium-diameter particles fill gaps among the larger-diameter particles.

Meanwhile, if each average particle diameter of the aluminum hydroxides as the components (C-1), (C-2) and (C-3) is outside the ranges, or if the constituent proportions of the components (C-1), (C-2) and (C-3) are outside the ranges, these hinder the preparation of a thermal conductive silicone composition which results in a thermal conductive silicone cured product having such high thermal conduction and light weight as a heat conductivity of 3.1 W/m·K or more and a relatively low viscosity.

Note that each average particle diameter is a value of volume-based cumulative average particle diameter (D50 median size) measured with a particle size analyzer LS 13 320 manufactured by BECKMAN COULTER.

The small-diameter aluminum hydroxide (filler) of the component (C-1) in combination with the medium-larger-diameter aluminum hydroxide of the component (C-2), (C-3) enhances the heat conductivity and flowability of the composition and prevents the precipitation of the filler. The average particle diameter of the small-diameter aluminum hydroxide is 0.1 μm or more and less than 4 μm, preferably 1 to 2 μm. If the average particle diameter is outside the ranges, the effects of enhancing the heat conductivity and flowability of the composition and preventing the filler precipitation in combination with the component (C-2), (C-3) are not obtained. One or two or more kinds of the aluminum hydroxide of the component (C-1) may be used as a composite.

The component (C-1) is blended in an amount of 10-25 wt %, preferably 19-21 wt %, of the aluminum hydroxide included in the component (C). If the mass proportion is outside the ranges, the effects of enhancing the heat conductivity and flowability of the composition and preventing the filler precipitation attributable to the combination with the component (C-2), (C-3) are not obtained.

The larger-diameter aluminum hydroxide (filler) of the component (C-3) enables significant enhancement of the heat conductivity. The average particle diameter of the larger-diameter aluminum hydroxide is 80 μm or more and 100 μm or less, preferably 85 to 95 μm. If the average particle diameter is outside the ranges, the effect of enhancing the thermal conduction is decreased, the viscosity of the composition is increased, or the processability is lowered. One or two or more kinds of the aluminum hydroxide of the component (C-3) may be used as a composite.

The component (C-3) is blended in an amount of 50-65 wt %, preferably 58-63 wt %, of the aluminum hydroxide included in the component (C). If the mass proportion is outside the ranges, the effect of enhancing the thermal conduction is decreased, the viscosity of the composition is increased, or the processability is lowered.

The amount of (C-1), (C-2) and (C-3) mentioned above is calculated based on 100% by weight of component (C) in the composition.

Thermally conductive fillers generally do not contain fumed silica or precipitated silica. In the composition of the present invention, the content of fumed silica and/or precipitated silica is less than 1 wt % preferably less than 0.1 wt %, calculated based on the total composition of 100 wt %.

The different heat conductive filler is not particularly limited. It is possible to use materials generally considered to be a heat conductive filler, for example, non-magnetic metal, such as copper or aluminum; metal oxide, such as alumina, silica, magnesia, colcothar, beryllia, titania, or zirconia; metal nitride, such as aluminum nitride, silicon nitride, or boron nitride; metal hydroxide, such as magnesium hydroxide; artificial diamond, silicon carbide, etc. Additionally, the particle size of 0.1 to 200 μm may be employed. One or two or more kinds thereof may be used as a composite.

The component (C) has to be blended in an amount of 800 to 4,000 parts by mass, preferably 900 to 2,000 parts by mass, more preferably 900 to 1,500 parts by mass, relative to 100 parts by mass of the component (A). If this blend amount is less than 800 parts by mass, the resulting composition has poor heat conductivity. If the blend amount exceeds 2,000 parts by mass, the kneading operability is impaired, and the cured product becomes significantly brittle. In order to obtain higher thermal conductivity and light weight products, the filling rate of the composition is generally greater than or equal to 0.88.

### Optional Component (D): Platinum Group Metal-Based Curing Catalyst

The component (D) is a platinum group metal-based curing catalyst and is not particularly limited, as long as the catalyst promotes an addition reaction of an alkenyl group derived from the component (A-1) and a Si—H group derived from the component (B). Examples of the catalyst include well-known catalysts used in hydrosilylation reaction. Specific examples include: platinum group metal simple substances, such as platinum (including platinum black), rhodium, and palladium; platinum chloride, chloroplatinic acid, and chloroplatinate, such as H₂PtCl₄·nH₂O, H₂PtCl₆·nH₂O, NaHPtCl₆·nH₂O, KHPtCl₆·nH₂O, Na₂PtCl₆·nH₂O, K₂PtCl₄·nH₂O, PtCl₄·nH₂O, PtCl₂, and Na₂HPtCl₄·nH₂O (here, in the formulae, n is an integer of 0 to 6, preferably 0 or 6); alcohol-modified chloroplatinic acid (see specification of U.S. Pat. No. 3,220,972); complexes of chloroplatinic acid with olefin (see U.S. Pat. No. 3,159,601 specification, U.S. Pat. No. 3,159,662 specification, and U.S. Pat. No. 3,775,452 specification); ones obtained by supporting a platinum group metal, such as platinum black and palladium, on a support, such as alumina, silica, or carbon; a rhodium-olefin complex, chlorotris(triphenylphosphine) rhodium (Wilkinson catalyst); complexes of platinum chloride, chloroplatinic acid, or chloroplatinate with a vinyl group-containing siloxane, particularly a vinyl group-no more containing cyclic siloxane; etc.

The component (D) is used in such an amount that the platinum group metal element content is 0.1 to 1,000 ppm relative to the component (A-1) based on mass. If the content is less than 0.1 ppm, sufficient catalyst activity is not obtained. If the content exceeds 1,000 ppm, the cost is merely increased without enhancing the effect of promoting the addition reaction, and the catalyst remaining in the cured product may decrease the insulating property, too.

### Component (E): Surface Treatment Agent

The inventive composition can be blended with a component (E) that is a surface treatment agent in order to uniformly disperse the heat conductive filler of the component (C) in a matrix of the component (A) by hydrophobizing the heat conductive filler of the component (C) during the composition preparation to improve the wettability with the organopolysiloxane of the component (A). As the component (E), a component (E-1) and a component (E-2) described below are particularly preferable.

Component (E-1): an alkoxysilane compound shown by the following formula (1),

R¹ₐR²_{b}Si(OR³)_{4-a-b} (1)
where each R¹ independently represents an alkyl group having 1 to 24 carbon atoms, preferably 6 to 24 carbon atoms, more preferably 12 to 18 carbon atoms, each R² independently represents an unsubstituted or substituted hydrocarbon group having 1 to 10 carbon atoms, preferably methyl, ethyl, each R³ independently represents an alkyl group having 1 to 6 carbon atoms, a represents an integer of 1 to 3, and b represents an integer of 0 to 2, provided that a+b is an integer of 1 to 3.
Examples of the alkyl group represented by R¹ in the formula (1) include a hexyl group, an octyl group, a nonyl group, a decyl group, a dodecyl group, a tetradecyl group, etc. When the number of carbon atoms in the alkyl group represented by R¹ satisfies the range of 6 to 15, the wettability of the component (A) is sufficiently enhanced, resulting in excellent handleability. Moreover, the composition has favorable low temperature characteristics.

Examples of the unsubstituted or substituted hydrocarbon group represented by R² include alkyl groups, such as a methyl group, an ethyl group, a vinyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups, such as a cyclopentyl group, a cyclohexyl group, and a cycloheptyl group; aryl groups, such as a phenyl group, a tolyl group, a xylyl group, a naphthyl group, and a biphenylyl group; aralkyl groups, such as a benzyl group, a phenylethyl group, a phenylpropyl group, and a methylbenzyl group; and groups obtained from these groups by substituting a part or all of hydrogen atoms bonded to a carbon atom(s) therein with a cyano group, a halogen atom, such as fluorine, chlorine, and bromine, or the like. Examples of such substituted groups include a chloromethyl group, a 2-bromoethyl group, a 3-chloropropyl group, a 3,3,3-trifluoropropyl group, a chlorophenyl group, a fluorophenyl group, a cyanoethyl group, a 3,3,4,4,5,5,6,6,6-nonafluorohexyl group, etc. Typical examples of the monovalent hydrocarbon group include ones having 1 to 10 carbon atoms, and particularly typical examples thereof include ones having 1 to 6 carbon atoms. Preferable examples of the monovalent hydrocarbon group include unsubstituted or substituted alkyl groups having 1 to 3 carbon atoms, such as a methyl group, an ethyl group, a propyl group, a chloromethyl group, a bromoethyl group, a 3,3,3-trifluoropropyl group, and a cyanoethyl group; and unsubstituted or substituted phenyl groups, such as a phenyl group, a chlorophenyl group, and a fluorophenyl group.

Examples of R³ include a methyl group, an ethyl group, a propyl group, a butyl group, a hexyl group, etc. Further, a and b are not particularly limited, as long as a is an integer of 1 to 3, b is an integer of 0 to 2, and a+b is an integer of 1 to 3. Preferably, a is 1 and b is 0.

The component (E-1) is preferably an alkoxysilane containing a C6-18 long-chain alkyl group; more preferably a trialkoxysilane containing a C6-18 long-chain alkyl group; more preferably hexadecyltrimethoxy silane, hexadecyltriethoxy silane, tetradecyltrimethoxy silane, tetradecyl-triethoxy silane, dodecyltrimethoxysilane, dodecyltriethoxysilane.

As the surface treatment agent of the component (E), any one or both of the component (E-1) may be blended alone or in combination. Here, the component (E) is in an amount of preferably 1 to 100 parts by mass, particularly preferably 1 to 50 parts by mass, more preferably 1 to 10 parts by mass, relative to 100 parts by mass of the component (A).

### Component (F): Property-Imparting Agent

As a component (F), it is possible to add an organopolysiloxane having a viscosity at 25° C. of 10 to 100,000 mPa·s and shown by the following formula (3),

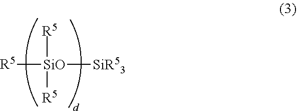

where each R⁵ independently represents a monovalent hydrocarbon group having 1 to 10 carbon atoms and no aliphatic unsaturated bond; and d represents an integer of 5 to 2,000.

The component (F) is used as appropriate in order to impart properties as a viscosity adjuster, plasticizer, and so forth for the thermal conductive silicone composition, but is not limited thereto. One kind of these may be alone, or two or more kinds thereof may be used in combination.

Each R⁵ independently represents an unsubstituted or substituted monovalent hydrocarbon group having 1 to 10 carbon atoms. Examples of R⁵ include alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups, such as a cyclopentyl group, a cyclohexyl group, and a cycloheptyl group; aryl groups, such as a phenyl group, a tolyl group, a xylyl group, a naphthyl group, and a biphenylyl group; aralkyl groups, such as a benzyl group, a phenylethyl group, a phenylpropyl group, and a methylbenzyl group; and groups obtained from these groups by substituting a part or all of hydrogen atoms bonded to a carbon atom(s) therein with a cyano group, a halogen atom, such as fluorine, chlorine, and bromine, or the like. Examples of such substituted groups include a chloromethyl group, a 2-bromoethyl group, a 3-chloropropyl group, a 3,3,3-trifluoropropyl group, a chlorophenyl group, a fluorophenyl group, a cyanoethyl group, a 3,3,4,4,5,5,6,6,6-nonafluorohexyl group, etc. Typical examples of the monovalent hydrocarbon group include ones having 1 to 10 carbon atoms, and particularly typical examples thereof include ones having 1 to 6 carbon atoms. Preferable examples of the monovalent hydrocarbon group include unsubstituted or substituted alkyl groups having 1 to 3 carbon atoms, such as a methyl group, an ethyl group, a propyl group, a chloromethyl group, a bromoethyl group, a 3,3,3-trifluoropropyl group, and a cyanoethyl group; and unsubstituted or substituted phenyl groups, such as a phenyl group, a chlorophenyl group, and a fluorophenyl group. A methyl group and a phenyl group are particularly preferable. d is preferably an integer of 5 to 2,000, particularly preferably an integer of 10 to 1,000, from the viewpoint of required viscosity.

Moreover, the viscosity at 25° C. is preferably 10 to 100,000 mPa·s, particularly preferably 100 to 10,000 mPa·s. When the viscosity is 10 mPa·s or more, the cured product of the resulting composition hardly exhibits oil bleeding. When the viscosity is 100,000 mPa·s or less, the resulting thermal conductive silicone composition has suitable flexibility.

When the component (F) is added to the inventive thermal conductive silicone composition, the addition amount is not particularly limited, could be 10 to 100 parts by mass relative to 100 parts by mass of the component (A). When the addition amount is in this range, this makes it easy to maintain the favorable flowability and operability of the thermal conductive silicone composition before curing, and to fill the composition with the heat conductive filler of the component (C).

In the inventive thermal conductive silicone composition, the dosage of the component (F) is preferably lower than 0.1 parts by mass, more preferably lower than 0.01 parts by mass, relative to 100 parts by mass of the component (A). In this way, it is possible to avoid oil leakage and contamination of the substrate of the thermally conductive silicone composition.

### Optional Component (G): Reaction Inhibitor

As a component (G), an addition reaction inhibitor is usable. As the addition reaction inhibitor, any of known addition reaction inhibitors used in usual addition reaction-curable silicone compositions can be employed. Examples thereof include acetylene compounds, such as 1-ethynyl-1-hexanol and 3-butyn-1-ol, various nitrogen compounds, organophosphorus compounds, oxime compounds, organochlorine compounds, etc. When the component (G) is blended, the use amount is preferably 0.01 to 1 parts by mass, more preferably 0.1 to 0.8 parts by mass, relative to 100 parts by mass of the component (A-1). With such a blend amount, the curing reaction proceeds sufficiently, and the molding efficiency is not impaired.

### Other Components

The inventive thermal conductive silicone composition may be further blended with other component(s), as necessary. Examples of the blendable optional components include heat resistance improvers, such as iron oxide and cerium oxide; viscosity adjusters, such as silica; colorants; release agents; etc.

### EMBODIMENTS

### Thermal Conductive Silicone Cured Product, and Production Method Therefor

A thermal conductive silicone cured product (thermally-conductive resin molded product) according to the present invention is a cured product of the above-described thermal conductive silicone composition. The curing conditions of curing (molding) the thermal conductive silicone composition may be the same as those for known addition reaction-curable silicone rubber compositions. For example, the thermal conductive silicone composition is sufficiently cured at normal temperature, too, but may be heated as necessary. Preferably, the thermal conductive silicone composition is subjected to addition curing at 100 to 120° C. for 8 to 12 minutes. Such a cured product (molded product) of the present invention is excellent in thermal conduction.

### Heat Conductivity of Molded Product

The inventive molded product has a heat conductivity of preferably 3.1 W/m. K or more, which is a measurement value measured at 25° C. by hot disc method. The product having a heat conductivity of 3.1 W/m·K or more is applicable to heat-generating members which generate large amounts of heat. Note that such a heat conductivity can be adjusted by coordinating the type of the heat conductive filler or combination of the particle sizes.

### Hardness of Molded Product

The inventive molded product is tested by a Zwick hardness tester. Note that such a hardness can be adjusted by changing the proportions of the component (A-1) and the component (B) to adjust the crosslinking density.

According to DIN53019, an Anton Paar MCR302 instrument was used to test the kinematic viscosity and static viscosity of the composition of the present invention.

Components (A) to (G) used in the following Examples and Comparative Examples are shown below.

### Component (A):

(A-1) Component, an organopolysiloxane shown by the following formula (5), wherein X represents a vinyl group, and n represents the number resulting in the viscosity of 120 mPa·s.

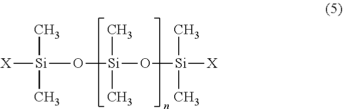

### Component (B):

(B-1) a side chain hydrogenpolysiloxane shown by the following formula (6), the hydrogen content is 1.7 mmol/g.

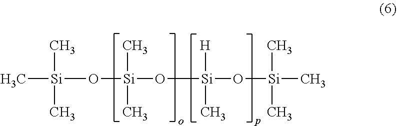

(B-2) a terminated hydrogenpolysiloxane shown by the following formula (5), wherein X represents hydrogen. The hydrogen content is 0.53 mmol/g.

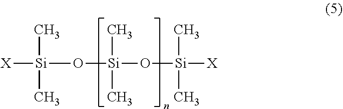

### Component (C):

(C-1-1) aluminum hydroxide with an average particle diameter of 1.5 μm
(C-1-2) aluminum hydroxide with an average particle diameter of 1.5 μm, surface treated by component (E-1)
(C-2) aluminum hydroxide with an average particle diameter of 10 μm
(C-3) aluminum hydroxide with an average particle diameter of 90 μm
(C-4-1) aluminum hydroxide with an average particle diameter of 50 μm
(C-4-2) aluminum hydroxide with an average particle diameter of 110 μm

### Component (D):

a 2-ethyl hexanol solution of 5 mass % of chloroplatinic acid

### Component (E):

Cetyltrimethoxysilane

### Component (G):

ethynyl methylidene carbinol as an addition reaction inhibitor.

The above-mentioned materials are provided by Wacker Chemie AG.

The components (A-1), (C) and (E) were added in predetermined amounts shown later under Examples and Comparative Examples in Table 1 or 2 and kneaded with a planetary mixer for 60 minutes.

To the mixture, the components (D) were added in predetermined amounts shown later in Table 2. The mixture was kneaded for 30 minutes.

To the resultant, the component (B) was further added in a predetermined amount shown later in Table 2 and kneaded for 30 minutes. Thus, compositions of Examples and Comparative Examples were obtained.

### Molding Method

After mixture, the compositions in Table 1 are obtained.

The obtained compositions in Table 2 were each poured into a mold with a size of 60 mm×60 mm×6 mm and molded using a press molding machine at 100° C. for 60 minutes.

### Evaluation Methods Heat Conductivity:

The obtained compositions in Table 1 and Table 2 were each poured into a mold with a size of 60 mm×60 mm×6 mm and were used to measure the heat conductivity.

Under conditions of 100° C. and 60 minutes, the compositions obtained in the following Examples and Comparative Examples in Table 2 were cured into sheet form with a thickness of 6 mm. Two sheets from each composition were used to measure the heat conductivity with a thermal conductivity meter (product name: TC3000E, manufactured by Xi'an Xiatech Electronics Co., Ltd.).

### Hardness:

The compositions obtained in the following Examples and Comparative Examples were cured into sheet form with a thickness of 6 mm as described above. Two sheets from each composition were stacked on each other and measured by a Zwick hardness tester to get a Shore00 value.

### Density (Density):

The measurement was performed by Mettler Toledo ML204.

TABLE 1
Silicone grease composition

| | Ex. 1 | C. Ex. 1 | Ex. 2 | Ex. 3 | C. Ex. 3 | C. Ex. 4 | C. Ex. 5 |
|---|---|---|---|---|---|---|---|
| (A-1) | 100.00 | 100.00 | 100.00 | 100.00 | 100.00 | 100.00 | 100.00 |
| (C-1-1) | 185.57 | 185.57 | 139.18 | 185.57 | | 185.57 | 185.57 |
| (C-1-2) | | | | | 185.57 | | |
| (C-2) | 185.57 | 185.57 | 324.74 | 278.35 | 278.35 | 371.13 | 371.13 |
| (C-3) | 556.70 | | 463.92 | 463.92 | | 371.13 | |
| (C-4-1) | | 556.70 | | | | | 371.13 |
| (C-4-2) | | | | | 463.92 | | |
| (E) | 3.09 | 3.09 | 3.09 | 3.09 | 3.09 | 3.09 | 3.09 |
| The weight | 2:2:6 | 2:2:6 | 1.5:3.5:5 | 2:3:5 | 2:3:5 | 2:4:4 | 2:4:4 |
| ratio of | | | | | | | |
| (C-1):(C-2):(C-3): | | | | | | | |
| the total amount | 927.84 | 927.84 | 927.84 | 927.84 | 927.84 | 927.84 | 927.84 |
| of heat conductive | | | | | | | |
| filler | | | | | | | |
| Filling rate | 0.90 | 0.90 | 0.90 | 0.90 | 0.90 | 0.90 | 0.90 |
| Viscosity D = 10 | 142 900 | 227 200 | 143 800 | 163 400 | 167 900 | 225 400 | 331 400 |
| 1/s mPa · s | | | | | | | |
| Thermal | 3.404 | 3.299 | 3.474 | 3.138 | 2.859 | 3.220 | 3.217 |
| conductivity | | | | | | | |
| W/mK | | | | | | | |

In Table 1, when the proportions of aluminum hydroxide of small, medium and large particle size are the same, the comparison between Ex. 1 and C. Ex. 1 shows that the silicone grease composition obtained by Ex. 1 (using (C-3) aluminum hydroxide with an average particle diameter of 90 μm) has lower viscosity and higher thermal conductivity than the silicone grease composition obtained in C. Ex. 1 (using (C-4-1) aluminum hydroxide with an average particle diameter of 50 μm). Comparing Ex. 3 and C. Ex. 3, it can be seen that the silicone grease composition obtained in Ex. 1 (using (C-3) aluminum hydroxide with an average particle diameter of 90 μm) has lower viscosity and higher thermal conductivity than the silicone grease composition obtained in C. Ex. 3 (using (C-4-2) aluminum hydroxide with an average particle diameter of 110 μm). That is, in the traditionally considered large particle size aluminum hydroxide range of 40-150 μm, the inventor found that the use of aluminum hydroxide with an average particle diameter around 90 μm can achieve much better performance.

Furthermore, when the ratio of (C-1):(C-2):(C-3) is 2:2:6, the product obtained in Ex. 1 has a clearer effect of lower viscosity and higher thermal conductivity than the product in C. Ex. 4.

TABLE 2
Thermal conductive gap filler composition

| | Ex. 10 | C. Ex. 10 |
|---|---|---|
| (A-1) | 100.00 | 100.00 |
| (B-1) | 1.93 | 1.93 |
| (B-2) | 31.51 | 31.51 |
| (C-1-1) | 228.94 | 228.94 |
| (C-2) | 228.94 | 228.94 |
| (C-3) | 686.82 | |
| (C-4-1) | | 686.82 |
| (D) | 0.64 | 0.64 |
| (E) | 5.14 | 5.14 |
| (G) | 0.32 | 0.32 |
| The weight ratio of (C-1):(C-2):(C-3): | 2:2:6 | 2:2:6 |
| the total amount of | 1144.69 | 1144.69 |
| heat conductive filler | | |
| Filling rate | 0.89 | 0.89 |
| Viscosity D = 10 1/s (mPa · s) | 105 900 | 155 500 |
| Thermal conductivity (W/mK) | 3.2 | 3.04 |
| Hardness Shore 00 | 56 | 59 |
| Density (g/cm³) | 2.06 | 2.03 |

In Table 2, the comparison between Ex. 10 and C. Ex. 10 shows that the caulk product obtained from Ex. 1 (using (C-3) aluminum hydroxide with an average particle diameter of 90 μm) has lower viscosity and higher thermal conductivity than that obtained from C. Ex. 10 the caulk product (using (C-4-1) aluminum hydroxide with an average particle diameter of 50 μm).

1-10. (canceled)

11. A composition, which contains:
a component (A), that is an organopolysiloxane, preferably a component (A-1) that is an organopolysiloxane having two or more alkenyl groups per molecule;
optional a component (B) that is an organohydrogenpolysiloxane having two or more hydrogen atoms directly bonded to silicon atoms and is contained in such an amount that the number of moles of hydrogen atoms directly bonded to silicon atoms in the component (B) is 0.1 to 5.0 times the number of moles of alkenyl groups derived from the component (A-1);
a component (C) that is a heat conductive filler
(C) component contains
10-25 wt % (C-1) aluminum hydroxide with an average particle diameter greater than or equal to 0.1 μm and less than or equal to 4 μm,
18-37 wt % (C-2) aluminum hydroxide with an average particle diameter of 4 μm or more and 20 μm or less,
48-65 wt % (C-3) aluminum hydroxide with an average particle diameter greater than or equal to 80 μm and less than or equal to 100 μm,
in (C-1), (C-2) and (C-3), the component (C) in the composition is calculated as 100 wt %,
optional a component (D) that is a platinum group metal-based curing catalyst having a platinum group metal element content of 0.1 to 1,000 ppm relative to the component (A-1) based on mass, wherein the filling rate of the heat conductive filler is greater than or equal to 0.88.

12. The composition according to claim 11, wherein the total amount of all aluminum hydroxide is greater than 95 wt %, calculated based on the total amount of heat conductive filler being 100 wt %.

13. The composition according to claim 11, wherein the density of the composition is equal to or less than 2.4 g/cm³.

14. The composition according to claim 11, wherein the thermal conductivity of the composition is greater than or equal to 3.1 W/mK.

15. The composition according to claim 11, wherein the weight ratio of (C) component to (E-1) component is between 100-800,
Component (E-1) is an alkoxysilane compound shown by the following formula (1); and
R¹ₐR²_{b}Si(OR³)_{4-a-b} (1)
wherein each R¹ independently represents an alkyl group having 1 to 24 carbon atoms, preferably 6 to 24 carbon atoms, more preferably 6 to 18 carbon atoms, more preferably 12 to 18 carbon atoms, each R² independently represents an unsubstituted or substituted hydrocarbon group having 1 to 10 carbon atoms, preferably methyl, ethyl, each R³ independently represents an alkyl group having 1 to 6 carbon atoms, preferably methyl, ethyl,
a represents an integer of 1 to 3, and b represents an integer of 0 to 2, provided that a+b is an integer of 1 to 3.

16. The composition according to claim 11, wherein (C) component containing
10-20 wt % (C-1) Aluminum hydroxide with an average particle diameter greater than or equal to 0.5 μm and less than or equal to 3 μm,
20-35 wt % (C-2) Aluminum hydroxide with an average particle diameter greater than or equal to 7 μm and greater than or equal to 15 μm,
50-60 wt % (C-3) Aluminum hydroxide with an average particle diameter greater than or equal to 85 μm and greater than or equal to 95 μm,
in (C-1), (C-2) and (C-3), the component (C) in the composition is calculated as 100% by weight.

17. The composition according to claim 11, wherein herein the ratio of (C-2)/(C-3) average particle diameter is between 7.0-12.0.

18. The composition according to claim 11, wherein the weight ratio of (C-1) (C-3) is between 0.2 and 0.4.

19. The composition according to claim 11, wherein the weight ratio of (C-2) (C-3) is between 0.2 and 0.8.

20. The composition according to claim 11, wherein the component (E) is in an amount of preferably 1 to 100 parts by mass, relative to 100 parts by mass of the component (A).
